(19) United States
(12) Patent Application Publication
(10) Pub. No.: US 2009/0188571 A1
(43) Pub. Date: Jul. 30, 2009

(54) POINT-OF-USE REGULATOR FOR GAS

(76) Inventor: Christian BASLER, Luebeck (DE)

Correspondence Address: MCGLEW & TUTTLE, PC, P.O. BOX 9227, SCARBOROUGH STATION, SCARBOROUGH, NY, 10510-9227, US

(21) Appl. No.: 12/358,433

(22) Filed: Jan. 23, 2009

(30) Foreign Application Priority Data
Jan. 26, 2008 (EP) 08 001 466.5

(51) Int. Cl. F16K 31/12

(52) U.S. Cl. 137/505

(57) ABSTRACT

A point-of-use regulator for gas is provided with a pressure regulator (16) and with a metering valve (14). The pressure regulator (18) and the metering valve (14) are integrated into a common valve block (18).

### CROSS REFERENCE TO RELATED APPLICATIONS

This application claims the benefit of priority under 35 U.S.C. § 119 of European Patent Application EP 08 001 466.5 filed Jan. 26, 2008, the entire contents of which are incorporated herein by reference.

### FIELD OF THE INVENTION

The invention relates to a point-of-use regulator for gas.

### BACKGROUND OF THE INVENTION

Point-of-use regulators for gas, are known for example in hospitals or laboratories, to which the most varied of apparatus and appliances may be connected for their gas supply. At the other side, the point-of-use regulator for gas is in connection for example with a central gas supply. Often, the most varied of elements such as pressure regulators, manometers, shut-off valves and metering valves are required on such point-of-use regulators for gas, in order to shut off the gas supply and to regulate it with regard to pressure and throughput. The respective elements for this are arranged one after the other and connected to one another in the desired manner, for example are screwed to one another. Thereby, the disadvantages are the large construction on the one hand, and a correspondingly extensive assembly and the danger of unsealedness at the connection locations of the individual elements on the other hand.

### SUMMARY OF THE INVENTION

It is the object of the invention to provide an improved point-of-use regulator for gas, which is constructed in a compact manner and is simple to assemble, as well as to reduce the danger of unsealedness (an unsealed state) between individual constituents of the point-of-use regulator for gas.

This object is achieved by a point-of-use regulator for gas according to the invention, which comprises, as a minimal combination, a pressure regulator as well as a metering valve. The pressure regulator serves for setting the pressure of the gas to be removed, and the metering valve for setting the throughput. Both elements are connected in series in the flow path, wherein the metering valve is preferably arranged downstream of the pressure regulator, I. e. at the exit side of the pressure regulator. According to the invention, the pressure regulator and the metering valve are integrated into a common valve block. I. e. the pressure regulator and the metering valve, according to the invention, form an integrated component. This has the advantage that on the one hand a compact construction may be achieved, and on the other hand it is not necessary to connect two individual parts, specifically the pressure regulator and the metering valve, to one another, for forming the point-of-use regulator for gas. A possible unsealedness in the connection location may be avoided in this manner. The compact construction furthermore provides the possibility of designing the appearance of the complete point-of-use regulator for gas in a more modern and attractive manner. Moreover, by way of this, one may achieve a clearer construction, which also improves the operability for the user. The integration of the metering valve and pressure regulator into a valve block, moreover, specifically permits a clear and easy to handle arrangement of the perspective operating elements for the pressure regulator and the metering valve.

According to a preferred embodiment, additionally a shut-off valve is integrated into the valve block, which serves for completely shutting off the gas supply. This is particularly preferred when the metering valve is not designed for the complete shut-off of the gas supply, and always permits a minimal throughput. The shut-off valve is preferably arranged in front of the pressure regulator in the flow direction, I. e. on the entry side of the pressure regulator. However, it is also possible to arrange the shut-off valve on the exit side of the pressure regulator, for example in the flow path between the pressure regulator and the metering valve, but also downstream of the metering valve. Thereby, the shut-off valve with the metering valve and the pressure regulator then form an integrated component in the common valve block, and this component permits a compact design of the complete point-of-use regulator for gas and moreover a clearer arrangement of the operating elements. In particular, all operating elements may be arranged closely to one another, so that a single-handed operation is possible without awkwardly having to grip around the point-of-use regulator for gas.

Moreover, a monometer may also be applied preferably on the valve block. Such a manometer may be integrated directly into the valve block, so that a display device is situated on an outer side or surface of the valve block. As an alternative, a connection may be formed in the valve block, to which connection the manometer is applied, so that it projects out of the valve block, in particular with its display element. The valve block may be additionally surrounded by a casing or a housing, which covers the point-of-use regulator for gas to the outside. If such housing is provided, the manometer, even if it is applied at the outside on the valve block, may be integrated together with the valve block into a common, enclosing housing. Whereas the valve block is preferably manufactured of metal, the housing may be designed as an injection moulded part of plastic, which permits a multifaceted shaping.

Usefully, connection channels for connecting the pressure regulator and metering valve, and, as the case may be, the shut-off valve and/or manometer, are formed in the valve block. I. e. all necessary connections or flow paths from the entry of the point-of-use regulator for gas, which is provided for connection for example to a central gas supply, up to the exit, at which apparatus to be supplied with gas may be connected, may be formed in the inside the valve block. Additional conduits between all elements in the valve block, I. e. pressure regulator, metering valve and, as the case may be, manometer and/or shut-off valve, which would increase the assembly effort and the danger of unsealedness, are done away with in this manner. All connections or flow paths may preferably be manufactured as channels or holes, which may be manufactured for example as bores, in the inside of the valve block.

Particularly preferably, the valve block is designed as one piece. Thus the valve block may be manufactured of a metal part. The required receivers for the pressure regulator, the metering valve and/or the shut-off valve and/or the manometer, as well as the necessary connection channels and connections, may be incorporated into such a metal part, in particular in a material-removing manner or in another suitable manner. Receivers in the form of holes or recesses, which are preferably open towards the surface of the valve block, are formed in the valve block, for the pressure regulator and the valves, i.e. the shut-off valve and metering valve, into which receivers these mentioned elements are inserted. The connection channels in the inside of the valve block run out into these receivers. As the case may be, the required valve seats may also be formed directly in the receivers. Alternatively, the valve seats may be inserted into the receivers as separate components.

According to a preferred embodiment, the pressure regulator is arranged at an end-side of the valve block. This is preferably that side, which faces the front in the installed condition of the point-of-use regulator for gas, i.e. faces an operating person. Thus a hand wheel for actuating the pressure regulator, may be arranged on the front side of the point-of-use regulator for gas. The valve block is preferably designed in an essentially cylindrical manner, and the rotation axis of the hand wheel extends along the longitudinal axis of the valve block. The valve block thereby preferably has an outer diameter, which corresponds essentially to the outer diameter of the hand wheel of the pressure regulator, so that a compact construction and an integral appearance of the point-of-use regulator for gas, are achieved.

The metering valve and/or the shut-off valve are preferably arranged on a peripheral surface of the valve block. I.e. in particular, receivers or recesses are formed in the valve block, which are open towards the peripheral surface, and into which the respective valves are inserted. Preferably, the valves thereby do not project essentially beyond the peripheral surface of the valve block, but at the most the actuation elements for these valves. The peripheral surface, in which the valves, i.e. metering valve and, as the case may be, shut-off valves are arranged, is preferably a peripheral surface which extends normally to the end-side, on which the pressure regulator is arranged. Preferably, it is thereby the case of an essentially cylindrical peripheral surface.

Moreover, at least one gas entry and a gas exit are arranged on the second end-side of the valve block and/or on a peripheral surface. The second end-side thereby is preferably that end-side, which is distant to the first end-side, on which the pressure regulator is arranged. In the installed condition, this is the rear end-side of the point-of-use regulator for gas. It is possible to alternatively design gas entries and/or gas exits on the valve block. Thus for example a rear gas exit may be provided on the end-side, and a peripheral gas exit on the peripheral surface, which may be connected in an alternative manner. The gas exit which is not used, may then be closed by a screw or a dummy plug. In a corresponding manner for example, a gas entry may also be provided on the second end-side, and a peripheral gas entry may be provided, which may be used in an alternative manner, in order to be able to realize different connection positions or installation positions with one and the same point-of-use regulator for gas, respectively one and the same valve block. The gas entry which is not used may then be accordingly closed, for example by a sealing screw or dummy plug. Moreover it is possible to arrange several gas entries and/or several gas exits, such that it is optionally possible to circumvent individual components such as the shut-off valve or metering valve in the valve block. Thus for example one may provide two gas exits of which one is arranged in front of the metering valve and one in the flow direction behind the metering valve. This, in an alternative manner, also permits the full throughput without the effect of the metering valve, additionally to the reduced throughput by way of the metering valve, out of the point-of-use regulator for gas.

A rotary ring which is arranged peripherally surrounding the valve block and which may be rotated about the longitudinal axis of the valve block, is provided for actuating the metering valve. This rotary ring is preferably inserted into the surface of the housing or peripherally surrounds the housing surface, in the case that the valve block is enveloped by a surrounding housing. Such a rotary ring, which peripherally surrounds the complete valve block or the complete point-of-use regulator for gas, may be gripped very easily. Moreover, such a large rotary ring permits a very exact metering with a comparatively small rotation angle, since a large rotary ring may also be set in a very delicate manner also over a small rotation angle. It is thus possible to realize a design with which the actuation distance for the rotary ring for actuating the metering valve is less than 360° and further preferably less than 180°. Thus a delicate metering is possible without having any peripheral gripping. The rotary ring may further be provided with detents which convey an improved feel for the operating person on setting the metering valve. Thus the individual detents particularly preferably may correspond to fixed throughput changes. The detent steps are preferably selected in a small manner, so that an accurate and delicate metering is possible.

The rotary ring is preferably provided with a toothing, which meshes with a toothed wheel of a valve spindle of the metering valve, wherein the longitudinal axis of the valve spindle extends preferably normally to the longitudinal axis of the valve block. The valve spindle is preferably inserted together with the remaining elements of the metering valve, in particular with a valve seat, in a recess or bore, which, proceeding from the peripheral surface, extends radially into the inside of the valve block. The valve spindle runs in a thread, so that the rotary movement of the valve spindle is converted into a travel movement for opening and closing the valve. The valve spindle, with one end, preferably projects slightly beyond the outer periphery of the valve block, so that a toothed wheel may be formed or arranged there. The toothing of the rotary ring, on its rotation, rotates the toothed wheel, by which means the valve spindle is rotated. The rotary axis of the rotary ring and valve spindle are thereby arranged normally to one another. The toothing on the rotary ring does not need to extend over the whole circumference of the rotary ring if the adjustment path of the rotary ring is less than 360°. The toothing is preferably arranged such that the teeth of the toothing on the rotary ring extend preferably parallel to the peripheral surface of the valve block, i.e. on a cylinder lateral area concentrically to the rotation axis of the rotary ring. The toothing of the toothed wheel is accordingly designed as a face spur toothing. A pairing in the manner of a bevel gear toothing would alternatively also be possible. In particular with this design, the valve spindle could then also be mounted in a thread such that it is not the valve spindle which moves in the axial direction, but a second element which is in engagement with the valve spindle via its thread, and which then opens and closes the valve by way of axial movement.

Further preferably, the rotary ring is arranged concentrically to a hand wheel of the pressure regulator. Thereby, the rotary ring and the hand wheel of the pressure regulator are preferably rotatable about the same rotation axis, i.e. further preferably, about the longitudinal axis of the valve block. Thus one may achieve a very compact design of the complete point-of-use regulator for gas. Preferably, the rotary ring is arranged offset to the hand wheel of the pressure regulator in the axial direction along the rotation axis. Thereby, seen from the first end-side, the rotary ring preferably lies axially behind the hand wheel of the pressure regulator respectively at its axial end. Further preferably, both parts connect to one another in a direct manner, or the rotary ring covers the axial end of the hand wheel of the pressure regulator. In this manner, one achieves an outer contour with fewer gaps, and as a whole, a harmonious outer design of the pressure regulator.

A slider element, which may be moved parallel to the longitudinal axis of the valve block, i.e. preferably parallel to the rotary axis of the rotary ring and/or of a hand wheel of a pressure regulator, is provided for actuating the shut-off valve. The slider element thereby is preferably arranged directly on the outer surface of the valve block or of a housing surrounding the valve block, so that it may be integrated into the remaining housing design also in a harmonious and preferably flush manner. Alternatively, the slider element may also be designed displaceable in the peripheral direction and in particular may likewise be designed as a rotary ring.

Particularly preferably, the slider element on the rotary ring is guided in a linearly movable manner parallel to the rotation axis of the rotary ring, for actuating the metering valve. I.e. the slider element may be integrated into the basic shape or outer contour of the rotary ring, so that all operating elements of the point-of-use regulator for gas may be easily gripped and lie close to one another. Thereby, the slider element may be designed or arranged in the rotary ring, such that it is rotatable together with the rotary ring. It would be possible to design the whole rotary ring simultaneously as a slider element, so that apart from a rotary movement, it may also carry out an axial movement parallel to its rotation axis, in order with this movement to actuate the shut-off valve. Preferably, the slider element however does not extend over the whole periphery of the rotary ring, but only around a part segment of the periphery, and there is guided in the rotary ring in an axially movable manner.

The shut-off valve itself is preferably actuated via a rocker lever mechanics, which may preferably be actuated via a slider element. Thereby, the slider element may be designed or arranged in the previously described manner. The rocker lever mechanics thereby serves to convert an axial movement parallel to the longitudinal axis of a valve block, or a movement in the peripheral direction, into an axial movement normal to the longitudinal axis. The shut-off valve itself is preferably arranged in a recess or a pocket hole which, proceeding from the peripheral surface of the valve block, extends radially to its longitudinal axis. The actuation movement of a valve element, for example of a piston or of membrane, is thereby likewise effected in the radial direction. A rocker lever may effect this movement, if the slider element is displaced outside the outer contour of the valve block parallel to its longitudinal axis, or in its peripheral direction, and acts on the rocker lever. Preferably, the shut-off valve or its actuation element is provided with locking positions, which correspond to the opened and the closed position of the shut-off valve. One may provide suitable locking elements, for example locking balls, for this. Moreover, it is possible to design the rocker lever mechanics as dead-centre mechanics, by which means one succeeds in the rocker lever locking in its two end positions respectively switch positions.

According to a further preferred embodiment, the rotary ring may be loaded in the axial direction with a spring force for actuating the metering valve, said force pressing the toothing of the rotary ring together with the toothing of the toothed wheel on the valve spindle. In this manner, the play from the geared engagement between the toothing and the toothed wheel may be alleviated, so that an accurate adjustment of the metering valve via the rotary ring is possible.

The manometer is preferably connected to the valve block as a hidden manometer. I.e. here, a connection recess in the form of a pocket hole is formed in the valve block, into which recess the manometer with a connection element is inserted. The manometer is then secured from falling out by way of a grub screw in the valve block, wherein the grub screw preferably engages in a recess or groove on the connection element of the manometer. The connection element and the recess on the valve block may be designed such that an insertion is only possible at a certain angular position, so that an automatic alignment of the manometer and valve block to one another is achieved on assembly.

The connections, i.e. the gas entries and gas exits on the valve block, are preferably designed such that they are connected to a thread as well as to a seat for the O-ring. Different sealing types or connection types are possible in this manner. Specifically, on the one hand a sealing alone by way of the thread or on the other hand, by way of an O-ring given a different type of connection, for example a clamping connection.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is an obliquely from the front perspective overall view of a point-of-use regulator for gas according to the invention;

FIG. 2 is a front view of the point-of-use regulator for gas according to FIG. 1;

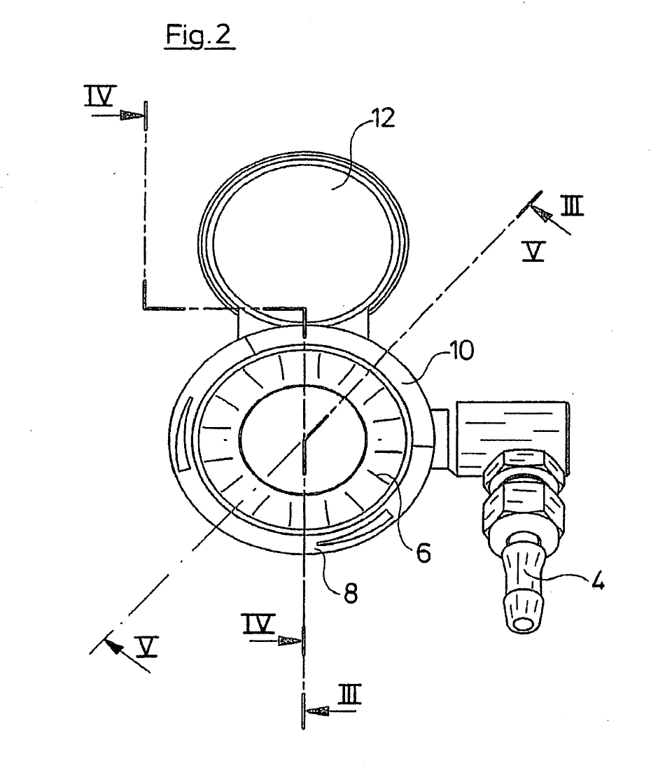

FIG. 3 is a sectioned view along line III-III in FIG. 2;

FIG. 4 is a sectioned view along line IV-IV in FIG. 2;

FIG. 5 is a sectioned view along line V-V in FIG. 2;

FIG. 6 is a lateral view of the point-of-use regulator for gas according to the preceding figures, wherein a part of the rotary ring for actuating the metering valve has been removed;

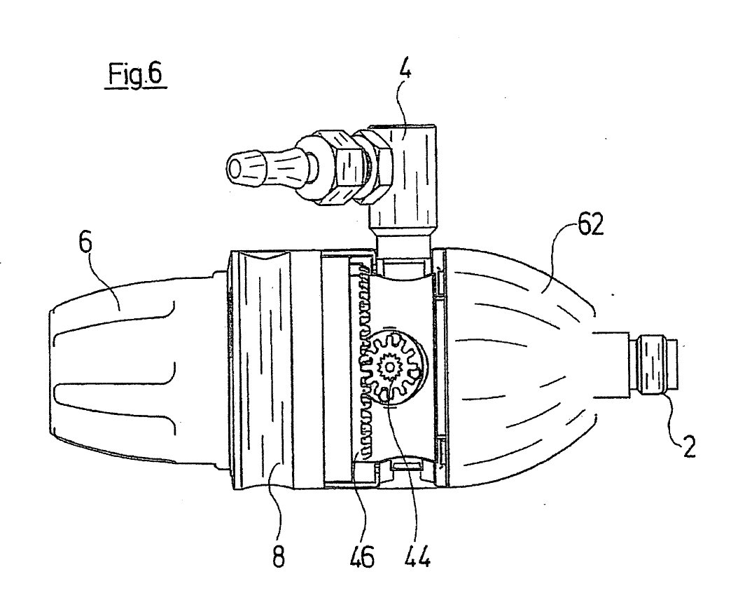

FIG. 7 is a further lateral view of the point-of-use regulator for gas according to the invention; and

FIG. 8 is a sectioned viewed along line VIII-VIII in FIG. 7.

### DESCRIPTION OF THE PREFERRED EMBODIMENT

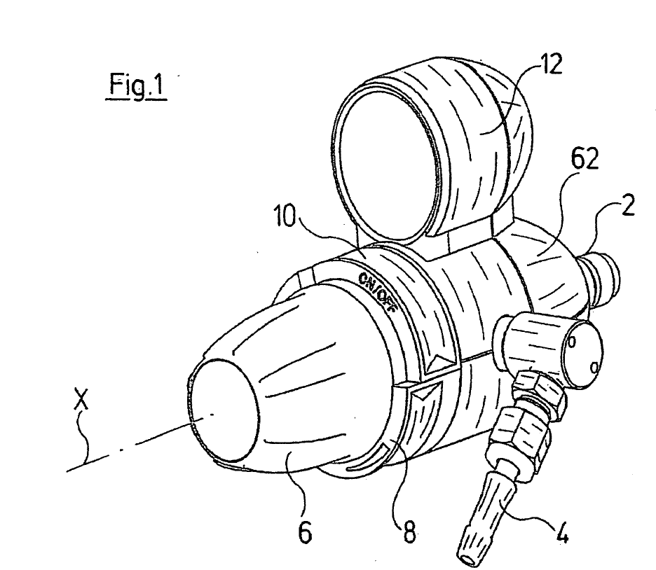

Referring to the drawings in particular, the shown point-of-use regulator for gas serves for the removal of gas from a gas source or a gas supply device. The point-of-use regulator for gas, for connecting to such a gas source or gas supply device, comprises a connection 2 which forms the gas entry, and a connection 4 which forms the gas exit. The connection 4 serves for the connection to external apparatus or installations which are to be supplied with gas, and this connection may also be designed differently than the manner of connecting to the connection flexible tubing, which is shown here. The point-of-use regulator for gas shown here, integrates three essential elements into a central component, specifically a pressure regulator, a metering valve and a shut-off valve, for which three actuation elements are formed or arranged on the outer side of the housing. This is firstly a hand wheel 6 for actuating the pressure regulator. The hand wheel 6 is arranged on the front side or end-side and is rotatable about the longitudinal axis X. Moreover, a rotary ring 8 is provided, which is arranged axially shifted in the direction of the longitudinal axis X at the rear end of the hand wheel 6, and is rotatable concentrically to this about the longitudinal axis X, in order to actuate a metering valve in the inside of the point-of-use regulator for gas. Moreover, a slider element 10 for actuating a shut-off valve is provided, said valve being displaceable parallel to the longitudinal axis X, in order to open or close the shut-off valve. In the positions which are displaced axially to the rear, i.e. from the front side of the hand wheel 6, which are shown in FIG. 1, the slider element 10 is located in the shut-off position in which the shut-off valve is closed. In the embodiment example shown here, the slider element 10 is designed as a segment of the rotary ring 8 and is guided in this in an axially displaceable manner. The slider element 10 is rotated together with the rotary ring 8, but is displaceable independently of its rotary movement. Thus one may achieve a shutting-off of the point-of-use regulator for gas, without a change in the metering setting.

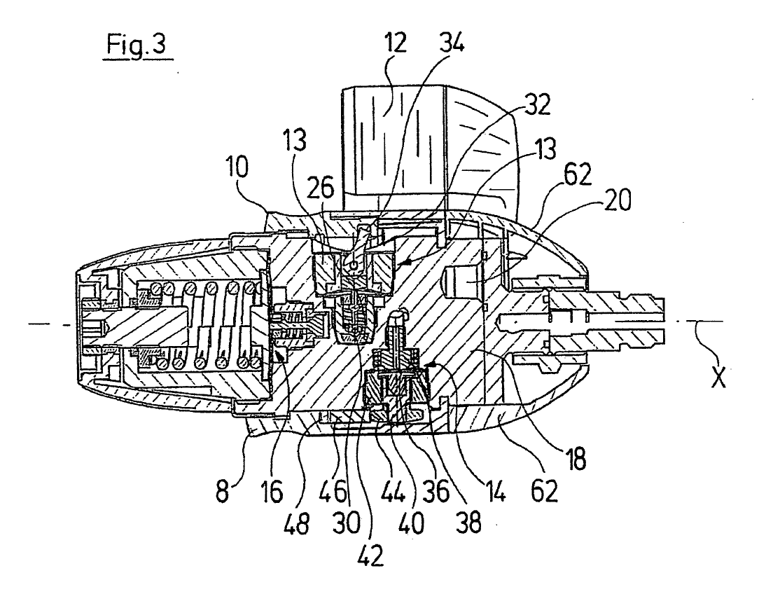

Moreover, it may be recognized in FIG. 1 that a manometer 12 is arranged on the outside of the housing. As is to be particularly recognized in the FIGS. 3, 4 and 5, the three essential elements of the shut-off valve 13, the metering valve 14 and the pressure regulator 16 are integrated into a common valve block 18. The valve block 18 is manufactured of metal as one piece. The pressure regulator 16, the metering valve 14 and the shut-off valve 13 are applied in recesses or holes in the valve block 18. Thereby, the pressure regulator 16 is arranged on a first front end-side of the valve block 18. The recesses for the shut-off element 13 and the metering valve 14 extend essentially in the radial direction to the longitudinal axis X of the valve block 18 from the peripheral surface. The valve block 18 thereby is designed in an essentially cylindrical manner.

The flow path in the inside of the valve block 18 is formed by bores or channels, which connect the individual elements to one another, but in the sectioned views present here, not all are fully shown. The flow path runs from the connection 2 which forms the gas entry, firstly to the shut-off valve 13 and from this then through a channel not shown in more detail, to the pressure regulator 16. The flow path runs from the pressure regulator 16 to the metering valve 14 and from there to the connection 4 which forms the exit.

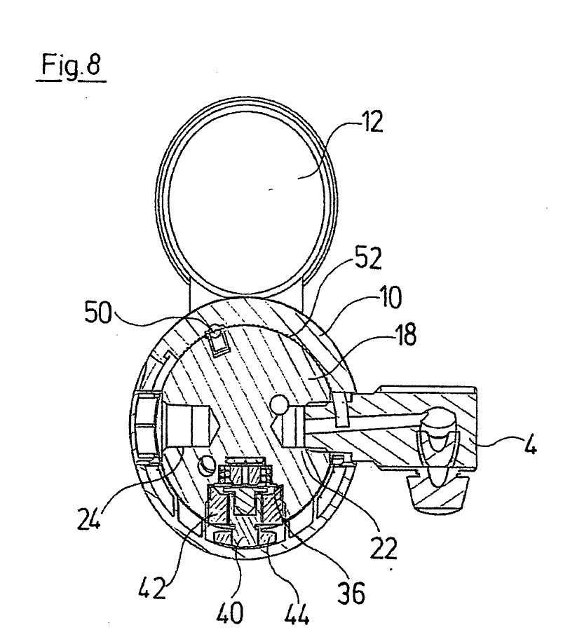

A second exit 20 is designed as an alternative connection to the connection 4, on the second rearward end-side of the valve block 18, and this second connection is however closed in the shown embodiment example. This second exit 20 could be used if a rearward exit is desired, for example if the shown point-of-use regulator for gas is to be integrated into an installation in a fixed manner. If the exit 20 is to be used, then accordingly one may make do without the connection 2, and the respective connection recess 22 in the valve block 18, which is to be recognized in FIG. 8, may be closed. A second connection recess 24 may be recognized in FIG. 8, which is closed in the shown example. This forms an alternative exit, which is connected to the internal flow path in the valve block 18, such that it is situated in front of the metering valve 14 in the flow direction. Thus the use of the connection recess 24 with a further connection would permit a gas removal with the complete flow, without metering by way of the metering valve 14.

The shut-off valve 13 is designed as a piston valve with an axially moving piston 26. In the closed position, the piston 26 comes to sealingly bear on the valve seat 28. The piston 26 is biased in the closure direction by way of a compression spring 30. The opening is effected by way of pivoting a rocker lever 32 about a pivot axis, which extends normally to the movement axis of the piston 26. The piston comprises a cam respectively has an eccentricity, which is designed such that the piston in the closure position is not pressed against the spring. In the opened position, the eccentricity respectively cam presses the piston against the spring, so that the piston is lifted from the valve seat 28 and the passage is opened. The slider element 10 is in engagement with the free end of the rocker lever 32 via a groove 34 which is formed in this slider element, so that the rocker lever 32 is pivoted about its pivot axis by way of displacing the slider element 10. The groove 34 extends in the peripheral direction about the longitudinal axis X, so that the end of the rocker lever 32 slides in the groove on rotation of the slider element 10 together with the rotary ring 8.

The metering valve 14 is designed as a membrane valve, with which a membrane 36 may be moved with respect to a valve seat 38. The movement of the membrane thereby is caused by a valve spindle respectively threaded spindle 40, which is arranged in a threaded groove 42. I.e. by way of rotating the threaded spindle 40 about its longitudinal axis, this is simultaneously moved axially on account of the thread, by which means the membrane on the valve seat 38 is moved to or away from this, depending on the rotation direction. The threaded spindle 40 extends radially outwards beyond the outer contour of the valve block 18. A toothed wheel 44 which is designed as a spur wheel, is arranged at the free end of the threaded spindle 40 which extends radially outwards. This toothed wheel 44 meshes with an arcuate rack or toothing 46, which is arranged in the rotary ring 8. A spring element 48 or several spring elements 48 are arranged between the rotary ring 8 and the toothed rod 46, said spring elements pressing the rack 46 against the toothed wheel 44, so that the teething of the toothed wheel 44 and of the rack 46 are kept in engagement without play. Thus the toothed wheel 44 is rotated via the rack 46 by way of rotating the rotary ring 18, and thus the metering valve 14 is opened or closed depending on the rotational direction. In order to permit a fine-touch setting, a detent mechanism is provided, which is produced by ball locking elements 50 which are arranged on the outer periphery of the valve block 18, and a corrugation 52 on the inner periphery of the rotary ring 8 and of the slider element 10. Three ball locking elements 50 are provided, which are distributed uniformly over the outer periphery of the valve block 18, in order to effect a symmetrical force introduction into the rotary ring 8.

The pressure regulator 16 is designed in the conventional manner, so that one may do away with a detailed description.

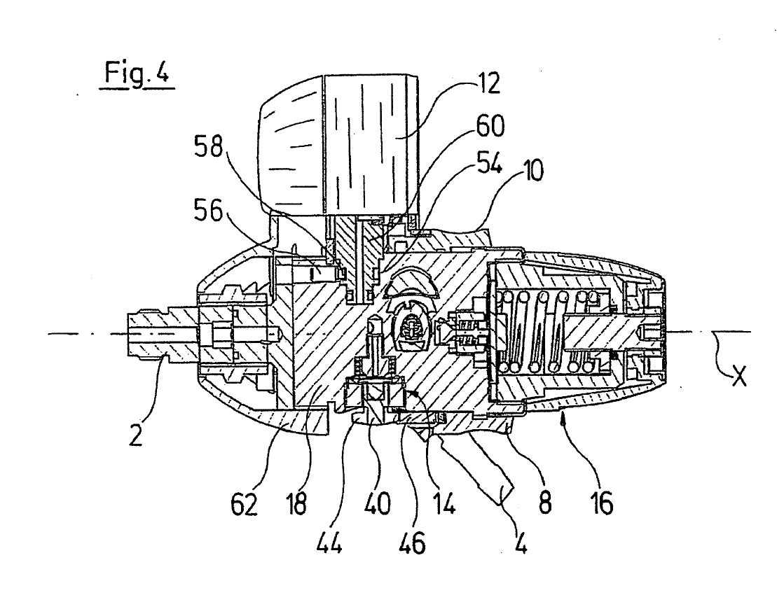

As may be recognized in FIG. 4, the manometer 12 is inserted in a recess or a pocket hole 54 on the outer periphery of the valve block 18. It is secured there by a grub screw 56 which engages into a groove 58 on the connection projection 60 of the manometer 12. The recess 54 is connected to the flow path of the pressure regulator 16 on the exit side, so that its exit pressure is displayed by the manometer 12.

The valve block 18 is surrounded to the outside by a housing 62 of plastic, which in the shown example is manufactured of several parts for reasons of manufacturing technology and assembly technology. The housing 62 thereby not only surrounds the valve block, but also the manometer 12, so that it closes the complete gas removal decide to the outside and defines the outer shape or fashion of the point-of-use regulator for gas. Thereby, the housing 62 may also cover openings or connections, which are not used, to the outside. For this, plugs which may be removed from the housing 62 may be provided, and alternatively it is also possible to provide different housings, depending on which connections on the valve block 18 are to be used. The surrounding housing 62 of plastic permits an aesthetic outer design of the whole point-of-use regulator for gas.

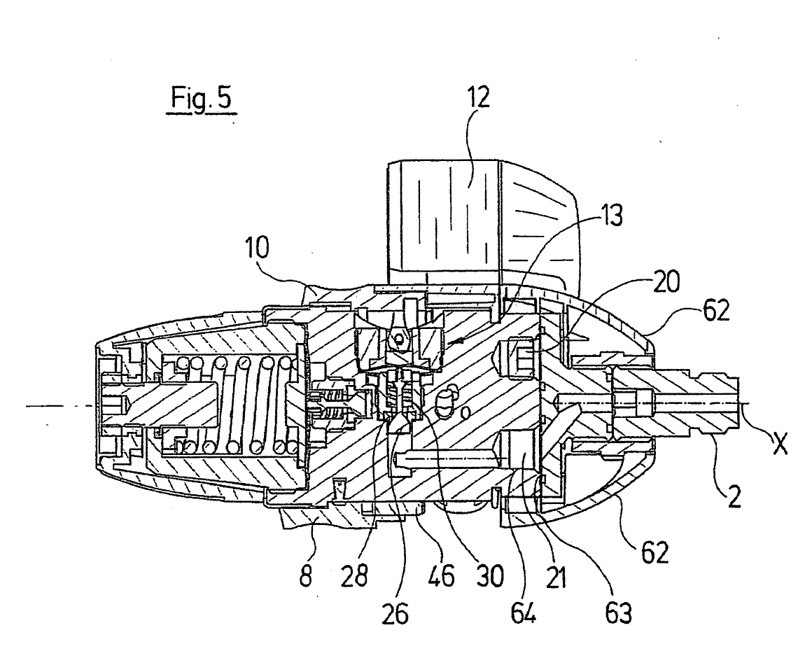

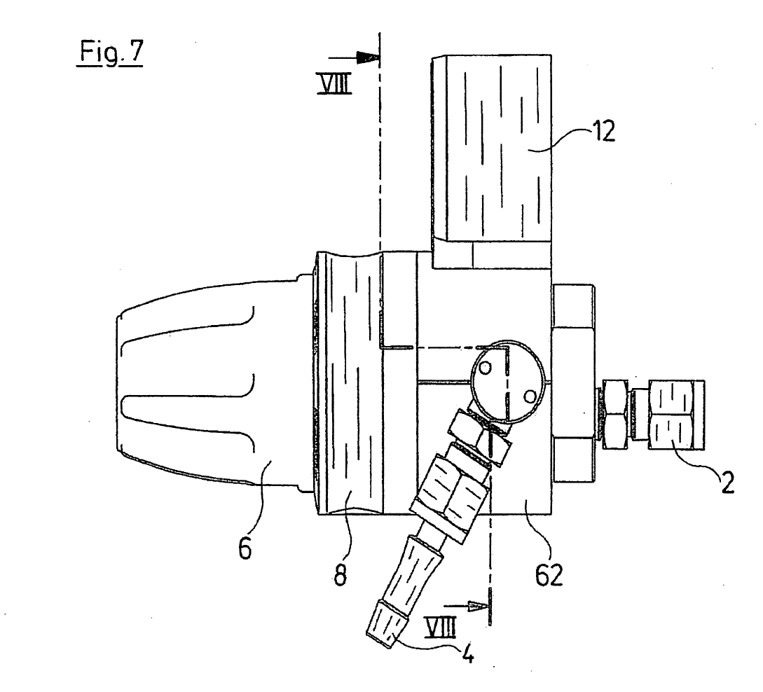

The connections or exits and entries which are formed in the valve block 18, are preferably designed such that they are suitable for sealing by way of an O-ring as well as for sealing by way of a thread. This is described for example by way of the connection recess 21 in FIG. 5, which is providing for connection to the connection 2 as an entry. The connection recess 21 is thus designed such that at its open outer side, it comprises a seat 63 for an O-ring on the one hand, and on the other hand is provided in its inside with a thread 64. In the shown example, the thread 64 is not used, and the sealing is effected via an O-ring on the seat 63. However, it is possible to screw a connection 2 directly into the thread 64 of the connection recess 21, as is represented in the view according to FIG. 7. The sealing is then effected via the thread 64.

While specific embodiments of the invention have been shown and described in detail to illustrate the application of the principles of the invention, it will be understood that the invention may be embodied otherwise without departing from such principles.

APPENDIX
List of reference numerals

| | |
|---|---|
| 2, 4 | connection |
| 6 | hand wheel |
| 8 | rotary ring |
| 10 | slider element |
| 12 | manometer |
| 13 | shut-off valve |
| 14 | metering valve |
| 16 | pressure regulator |
| 18 | valve block |
| 20 | exit |
| 21 | connection recess |
| 22 | recess |
| 24 | connection recess |
| 26 | piston |
| 28 | valve seat |
| 30 | compression spring |
| 32 | rocker lever |
| 34 | groove |
| 36 | membrane |
| 38 | valve seat |
| 40 | threaded spindle |
| 42 | thread receiver |
| 44 | toothed wheel |
| 46 | rack |
| 48 | spring element |
| 50 | ball locking element |
| 52 | corrugation |
| 54 | pocket hole |
| 56 | grub screw |
| 58 | groove |
| 60 | connection device |
| 62 | housing |
| 63 | seat |
| 64 | thread |
| X | longitudinal axis |

What is claimed is:

1. A point-of-use regulator for gas, the point-of-use regulator comprising:
a pressure regulator;
a metering valve; and
a common valve block, said pressure regulator and said metering valve being integrated into said common valve block.

2. A point-of-use regulator for gas, according to claim 1, further comprising:
a shut-off valve integrated into said common valve block.

3. A point-of-use regulator for gas, according to claim 1, further comprising:
a manometer applied on to said common valve block.

4. A point-of-use regulator for gas, according to claim 1, further comprising:
connection channels for connecting said pressure regulator and said metering valve, said connection channels being formed in said common valve block.

5. A point-of-use regulator for gas, according to claim 1, wherein said common valve block is designed as one piece.

6. A point-of-use regulator for gas, according to claim 1, wherein said pressure regulator is arranged on a first end-side of said common valve block.

7. A point-of-use regulator for gas, according to claim 1, wherein said metering valve and said shut-off valve are arranged on a peripheral surface of said common valve block.

8. A point-of-use regulator for gas, according to claim 1, wherein at least one gas entry and one gas exit are arranged on an end-side of said common valve block and/or in a peripheral surface.

9. A point-of-use regulator for gas, according to claim 1, further comprising a rotary ring peripherally surrounding said common valve block, said rotary ring being rotatable about a longitudinal axis of said common valve block, said rotary ring for actuating said metering valve.

10. A point-of-use regulator for gas, according to claim 9, wherein said rotary ring comprises a toothing, which meshes with a toothed wheel of a valve spindle of said metering valve, wherein a longitudinal axis of the valve spindle extends normally to the longitudinal axis of said common valve block.

11. A point-of-use regulator for gas, according to claim 9, wherein said rotary ring is arranged concentrically to a hand wheel of said pressure regulator.

12. A point-of-use regulator for gas, according to claim 2, further comprising a slider element for movement parallel to a longitudinal axis of said common valve block, said slider element for actuating said shut-off valve.

13. A point-of-use regulator for gas, according to claim 12, a rotary ring for actuating said metering valve wherein said slider element is guided in a linearly movable manner on said rotary ring.

14. A point-of-use regulator for gas, according to claim 2, wherein said shut-off valve is actuated via a rocker lever mechanism which may be actuated via a slider element.

15. A point-of-use regulator for gas, according to claim 2, further comprising:
connection channels for connecting the pressure regulator and metering valve and said shut-off valve, said connection channels being formed in said common valve block.

16. A point-of-use regulator for gas, according to claim 3, further comprising:
connection channels for connecting the pressure regulator and metering valve and said manometer, said connection channels being formed in said common valve block.

17. A point-of-use regulator for gas, according to claim 10, wherein said rotary ring is arranged concentrically to a hand wheel of said pressure regulator.
